(19) United States
(12) Patent Application Publication
(10) Pub. No.: US 2019/0050497 A1
(43) Pub. Date: Feb. 14, 2019

(54) SERVER, CONTROL METHOD FOR SERVER, AND CONTROL PROGRAM FOR SERVER

(71) Applicant: GURUNAVI, INC., Tokyo (JP)

(72) Inventors: Seiichiro KUBO, Tokyo (JP); Satoshi OHISA, Tokyo (JP)

(73) Assignee: GURUNAVI, INC., Tokyo (JP)

(21) Appl. No.: 15/908,891

(22) Filed: Mar. 1, 2018

(30) Foreign Application Priority Data
Aug. 10, 2017 (JP) 2017-155816

(51) Int. Cl. G06F 17/30; G06K 9/62

(52) U.S. Cl. CPC G06F 17/30979; G06F 3/0482; G06K 9/6201

(57) ABSTRACT

A control method for a server includes controlling the server to execute: transmitting to a terminal for registration first display data for displaying a plurality of search conditions in a selectable manner and displaying a plurality of items of characteristic information in a selectable manner in association with a selected search condition; upon receiving a registration request including the search condition and the characteristic information to be associated with the search condition, registering the search condition and the characteristic information in association with an establishment; and upon receiving an establishment list display request including the search condition designated by a user via a user terminal, transmitting to the user terminal second display data for displaying a list of establishments associated with the search condition in association with the characteristic information associated with the search condition. In the registration, expense for registration is determined.

### INCORPORATION BY REFERENCE

The disclosure of Japanese Patent Application No. 2017-155816 filed on Aug. 10, 2017 including the specification, drawings and abstract is incorporated herein by reference in its entirety.

### BACKGROUND OF THE INVENTION

### 1. Field of the Invention

The present disclosure relates to a server, a control method for the server, and a control program for the server.

### 2. Description of Related Art

Conventionally, an information providing system that provides information on an establishment to a user terminal such as a mobile phone via a communication network has been known. In such an information providing system, a server that receives a search condition designated by a user through the user terminal provides a list of establishments that match the search condition to the user terminal.

Japanese Patent Application Publication No. 2009-116424 discloses an automatic reservation system that transmits a list of establishment information to a mobile terminal on the basis of condition information such as application information in accordance with purpose of use, transmitted from the mobile terminal. A user acquires a list of establishments that match the desired purpose of use from the automatic reservation system by transmitting the application information to the automatic reservation system.

According to the automatic reservation system disclosed in Japanese Patent Application Publication No. 2009-116424, the user can acquire a list of establishments that match the desired purpose of use. However, in the case where there are a number of establishments that match the purpose of use, the user needs to find an establishment that the user is to use among the number of establishments. In a system that displays a list of establishments that match a search condition designated by a user, it is required to enable the user to find an establishment that matches a search condition better with high accuracy.

### SUMMARY OF THE INVENTION

An object of the present invention is to provide a server, a control method for the server, and a control program for the server that enable a user to find an establishment that matches a search condition better with high accuracy in a system that displays a list of establishments that match the search condition designated by the user.

One aspect of the present embodiment is a control method for a server connectable to a storage circuity in which a plurality of search conditions and a plurality of items of characteristic information indicating characteristics of establishments are stored, a terminal for registration and a user terminal. The control method includes controlling the server to execute: transmitting to the terminal for registration first display data for displaying the plurality of search conditions in a selectable manner and displaying the plurality of items of characteristic information in a selectable manner in association with a selected search condition; upon receiving a registration request including a search condition and characteristic information to be associated with the search condition from the terminal for registration, registering the search condition and the characteristic information in association with an establishment; and upon receiving an establishment list display request including a search condition designated by a user through the user terminal, transmitting to the user terminal second display data for displaying a list of establishments each associated with the search condition in association with the characteristic information associated with the search condition. In registration, expense for registration is determined in accordance with the number of items of the characteristic information registered in association with the search condition.

Further, one aspect of the present embodiment is a server connectable to a storage circuity in which a plurality of search conditions and a plurality of items of characteristic information indicating characteristics of establishments are stored, a terminal for registration and a user terminal. The server includes a first transmitting circuity configured to transmit to the terminal for registration first display data for displaying the plurality of search conditions in a selectable manner and displaying the plurality of items of characteristic information in a selectable manner in association with a selected search condition, a registering circuity configured to, upon receiving a registration request including a search condition and characteristic information to be associated with the search condition from the terminal for registration, register the search condition and the characteristic information in association with an establishment, and a second transmitting circuity configured to, upon receiving an establishment list display request including a search condition designated by a user through the user terminal, transmit to the user terminal second display data for displaying a list of establishments each associated with the search condition in association with the characteristic information associated with the search condition. The registering circuity determines expense for registration in accordance with the number of items of the characteristic information registered in association with the search condition.

Further, one aspect of the present embodiment is a non-transitory tangible computer-readable storage medium having a control program for a server stored therein, the server being connectable to a storage circuity in which a plurality of search conditions and a plurality of items of characteristic information indicating characteristics of establishments are stored, a terminal for registration and a user terminal. The present control program causes the server to execute: transmitting to the terminal for registration, first display data for displaying the plurality of search conditions in a selectable manner and displaying the plurality of items of characteristic information in a selectable manner in association with a selected search condition; upon receiving a registration request including a search condition and characteristic information to be associated with the search condition from the terminal for registration, registering the search condition and the characteristic information in association with an establishment; and, upon receiving an establishment list display request including a search condition designated by a user through the user terminal, transmitting to the user terminal, second display data for displaying a list of establishments each associated with the search condition in association with characteristic information associated with the search condition. In registration, expense for registration is determined in accordance with the number of items of the characteristic information registered in association with the search condition.

According to the server, the control method for the server and the control program according to the present embodiment, in a system that displays a list of establishments that match a search condition designated by the user, the user can easily find an establishment that matches the search condition better.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic diagram for explaining outline of an information providing system;

FIG. 2 is a schematic diagram for explaining outline of the information providing system;

FIG. 3 is a diagram illustrating an illustrative schematic configuration of the information providing system;

FIG. 4 is a diagram illustrating an illustrative schematic configuration of a server;

FIG. 5A is a diagram illustrating an illustrative data structure of various kinds of tables;

FIG. 5B is a diagram illustrating an illustrative data structure of various kinds of tables;

FIG. 6 is a diagram illustrating an illustrative data structure of various kinds of tables;

FIG. 7 is a diagram illustrating an illustrative schematic configuration of an establishment terminal;

FIG. 8 is a diagram illustrating an illustrative registration screen;

FIG. 9 is a diagram illustrating an illustrative schematic configuration of a user terminal;

FIG. 10 is a diagram illustrating an illustrative designation screen;

FIG. 11 is a diagram illustrating an example of an establishment list screen;

FIG. 12 is a diagram illustrating another example of the establishment list screen;

FIG. 13 is a diagram illustrating an illustrative operation sequence of the information providing system;

FIG. 14 is a flowchart illustrating illustrative registration processing; and

FIG. 15 is a diagram illustrating an illustrative operation sequence of the information providing system.

### DETAILED DESCRIPTION OF EMBODIMENTS

A server, a control method for the server and a control program for the server according to an aspect of the present disclosure will be described below with reference to the drawings. However, it should be noted that the technical scope of the present disclosure is not limited to the embodiments, and includes the inventions recited in claims and equivalents thereof.

Outline of Information Providing System 1

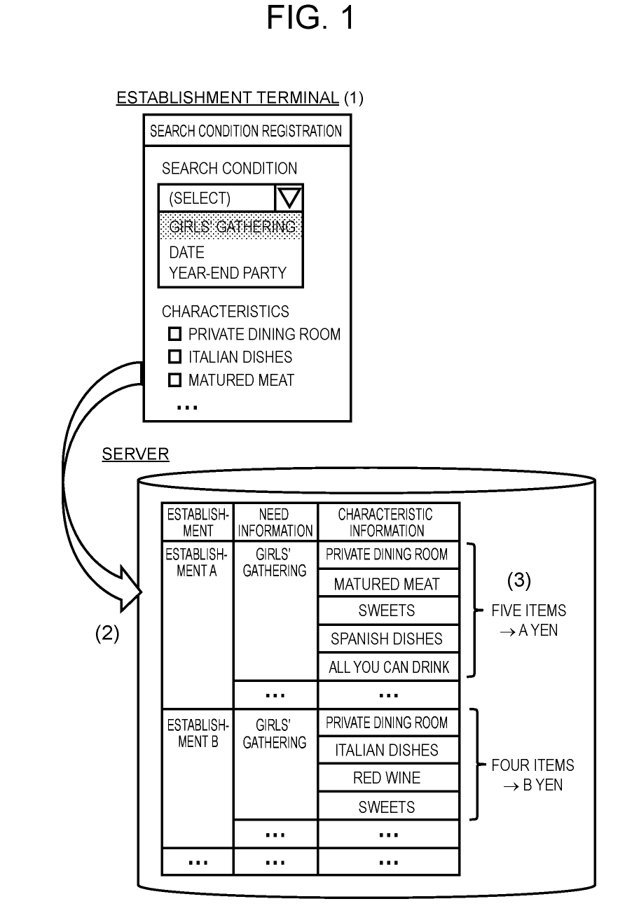

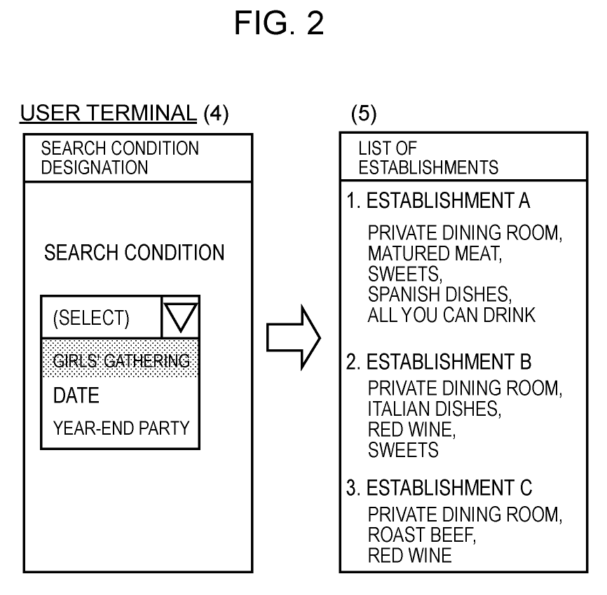

Outline of an information providing system will be described below with reference to schematic diagrams illustrated in FIG. 1 and FIG. 2.

The information providing system includes a server, an establishment terminal and a user terminal. In the information providing system, search conditions (search keywords) respectively corresponding to establishments and characteristic information corresponding to the search conditions are registered in association with each other in the server for each of a plurality of establishments. The search conditions are conditions of each establishment needed by a user, that is, need information indicating needs of the user, and, for example, usage scenes in which the user uses each establishment or purpose of use of each establishment, such as a “girls' gathering”, a “date” and a “year-end party”. The characteristic information, which is information indicating characteristics of each establishment for embodying the needs of the user, includes persistence, a selling point, a catch-phrase, or the like of each establishment. The characteristic information indicates, for example, facilities of each establishment, dishes provided at each establishment, drinks or service, a location of each establishment, or the like, such as a “private dining room”, “matured meat”, “red wine”, “all you can drink” and “close to the station”.

To register a search condition and characteristic information, first, a screen in which a plurality of search conditions are displayed in a selectable manner and a plurality of items of characteristic information are displayed in association with the selected search condition in a selectable manner, is caused to be displayed at an establishment terminal (1). If the server receives a registration request including a search condition and characteristic information to be associated with the search condition from the establishment terminal, the server registers the search condition and the characteristic information in association with an establishment at which the establishment terminal is provided (2). At this time, the server determines expense for registration in accordance with the number of items of characteristic information registered in association with the search condition (3). Then, the user terminal accepts designation of a search condition by the user (4) and transmits the designated search condition to the server. If the server receives the search condition from the user terminal, the server causes a screen in which a list of establishments each associated with the search condition is displayed in association with characteristic information associated with the search condition, to be displayed at the user terminal (5).

In the example illustrated in FIG. 1, concerning an establishment A, five items of characteristic information are registered in association with a search condition of a “girls' gathering”, and expense for the registration is determined in accordance with five items of characteristic information. Meanwhile, concerning an establishment B, four items of characteristics information are registered in association with a search condition of a “girls' gathering”, and expense for the registration is determined in accordance with four items of characteristic information.

In the case where there are a plurality of establishments associated with the designated search condition, the user finds an establishment that matches the search condition better on the basis of characteristic information associated with the search condition. In the case where characteristic information corresponding to each search condition can be unlimitedly registered, there is a possibility that each establishment may register characteristic information with low relevance with the search condition as well as characteristic information with high relevance with the search condition to attract user's attention. Because the information providing system determines expense for registration in accordance with the number of items of characteristic information registered in association with the search condition, each establishment registers only characteristic information with high relevance with the search condition to prevent increase in expense for registration. By this means, only characteristic information with high relevance with the search condition is displayed in a list screen of each establishment associated with the search condition designated by the user, so that the user can find an establishment that matches the search condition better with high accuracy.

Configuration of Information Providing System 1

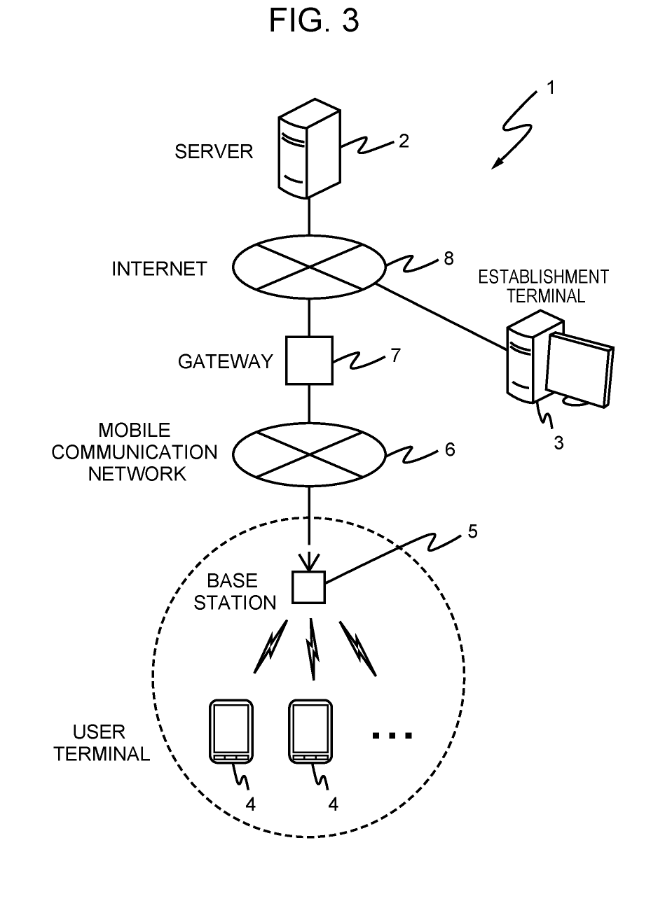

FIG. 3 is a diagram illustrating an illustrative schematic configuration of the information providing system 1.

The information providing system 1 includes a server 2, one or more establishment terminals 3, and a plurality of user terminals 4. The server 2 and the establishment terminal 3 can be connected to each other via a communication network, and, for example, are connected to each other via the Internet 8. Further, the server 2 and the user terminal 4 can be connected to each other via the communication network, and, for example, are connected to each other via a base station 5, a mobile communication network 6, a gateway 7 and the Internet 8. Note that the establishment terminal 3 is an example of the terminal for registration, and, for example, a terminal that is possessed by a person related to the establishment and that is provided at an establishment such as a restaurant operated by the person related to the establishment or a terminal possessed by a representative who performs registration by receiving a request from each establishment. The user terminal 4 is a mobile terminal possessed by a user who uses an establishment or a plurality of menu terminals, or the like, that are provided at each establishment for allowing a user of each establishment to order menu items.

A program (for example, a conversion program) executed at the server 2 and a program (for example, a browsing program) executed at the establishment terminal 3 and the user terminal 4 perform communication using communication protocol such as Hypertext Transfer Protocol (HTTP).

Schematic Configuration of Server 2

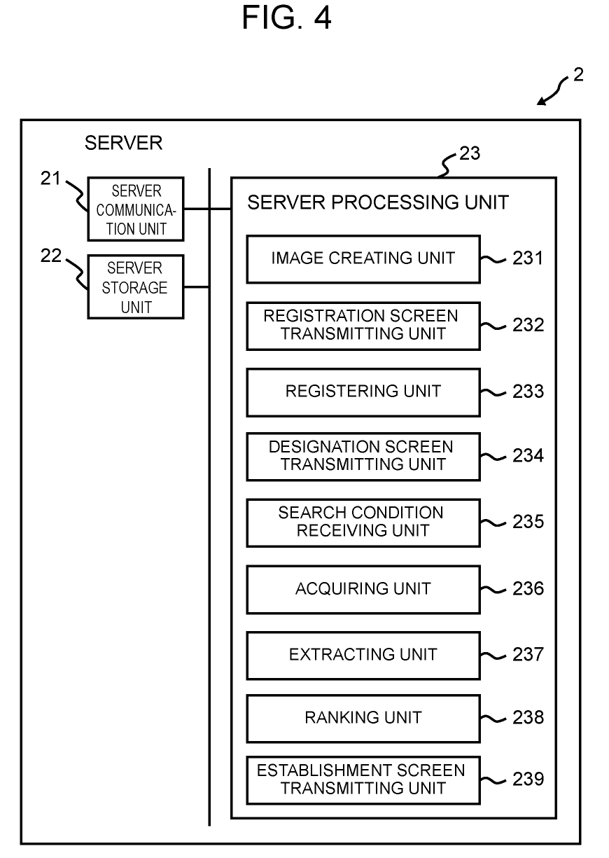

FIG. 4 is a diagram illustrating an illustrative schematic configuration of the server 2.

The server 2 registers a search condition corresponding to each establishment and characteristic information corresponding to the search condition in association with each other for each of a plurality of establishments and transmits to the user terminal 4 display data for displaying a list of establishments associated with a search condition designated by the user along with the characteristic information. To achieve this, the server 2 includes a server communication unit 21, a server storage unit 22, and a server processing unit 23.

The server communication unit 21 includes a communication interface circuit for connecting the server 2 to the Internet 8. The server communication unit 21 supplies data received from the establishment terminal 3, the user terminal 4, or the like, to the server processing unit 23. Further, the server communication unit 21 transmits data supplied from the server processing unit 23 to the establishment terminal 3, the user terminal 4, or the like.

The server storage unit 22 includes, for example, at least one of a semiconductor memory, a magnetic disk device and an optical disc device. The server storage unit 22 stores a driver program, an operating system program, an application program, data, or the like, to be used for processing by the server processing unit 23. For example, the server storage unit 22 stores a communication device driver program, or the like, for controlling the server communication unit 21 as the driver program. Various kinds of programs may be installed to the server storage unit 22 using a publicly known setup program, or the like, from a non-transitory portable computer-readable storage medium such as, for example, a CD-ROM (Compact Disc Read Only Memory) and a DVD-ROM (Digital Versatile Disc Read Only Memory).

The server storage unit 22 stores a search condition table, a characteristic information table, an establishment table, or the like, which will be described later, as data. Further, the server storage unit 22 temporarily stores temporal data relating to predetermined processing.

Note that the table described in the present embodiment is an example of a form of a database, and may be a form such that data is pooled within a server.

The server processing unit 23 includes one or more processors and their peripheral circuits. The server processing unit 23 generally controls the whole operation of the server 2, and is, for example, a CPU (Central Processing Unit). The server processing unit 23 controls operation of the server communication unit 21, or the like, so that various kinds of processing of the server 2 are executed in accordance with an appropriate procedure on the basis of the programs, or the like, stored in the server storage unit 22. The server processing unit 23 executes processing on the basis of the programs (such as the operating system program, the driver program and the application program) stored in the server storage unit 22. Further, the server processing unit 23 can execute a plurality of programs (such as application programs) in parallel.

The server processing unit 23 includes a screen creating unit 231, a registration screen transmitting unit 232, registering unit 233, a designation screen transmitting unit 234, a search condition receiving unit 235, an acquiring unit 236, an extracting unit 237, a ranking unit 238, an establishment screen transmitting unit 239, or the like. Each unit of the server processing unit 23 is a function module implemented by a program executed on a processor of the server processing unit 23. Alternatively, each unit of the server processing unit 23 may be implemented at the server 2 as an independent integrated circuit, a microprocessor or a firmware.

Data Structure of Various Kinds of Tables

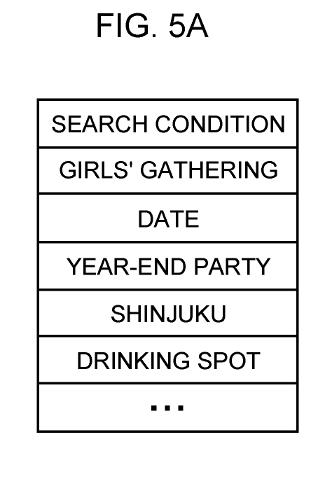

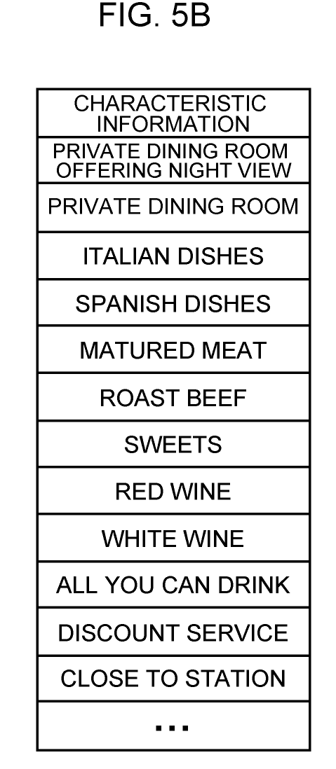

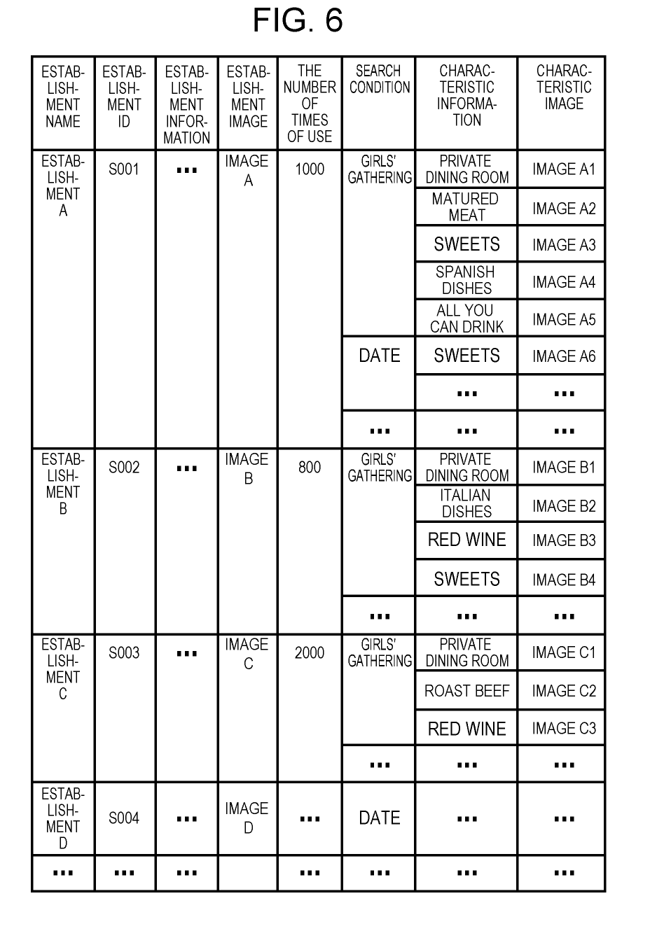

FIG. 5A, FIG. 5B and FIG. 6 are diagrams illustrating illustrative data structures of various kinds of tables. Note that all or part of various kinds of tables described below may be stored in one or more other apparatuses (such as a database apparatus) which can be connected to the server 2 and which is different from the server 2, instead of being stored in the server storage unit 22. In this case, the server 2 acquires information included in the tables by accessing other apparatuses that store the tables when using information included in these various kinds of tables. Further, in the present example, information items included in each table may be stored in a form other than a table, and, for example, may be stored independently of each other.

FIG. 5A illustrates a search condition table. In the search condition table, all of a plurality of search conditions defined in the information providing system 1 are stored. The search condition is a condition of each establishment needed by the user, that is, need information indicating needs of the user, and is a usage scene in which the user uses each establishment or purpose of use. As the search condition, a usage scene such as, for example, a “girls' gathering”, a “date” and a “year-end party” and purpose of use (or usage location, facility to be used, or the like) such as “Shinjuku” and a “drinking spot” are set. Further, as the search condition, a condition including a plurality of elements like a “girls' gathering at Shinjuku” or a “drinking spot in Shinjuku” may be set.

FIG. 5B illustrates a characteristic information table. In the characteristic information table, all of a plurality of items of characteristic information defined in the information providing system 1 are stored. The characteristic information is information indicating characteristics of each establishment for embodying the needs of the user, and is persistence, a selling point, a catch-phrase, or the like, of each establishment. As the characteristic information, for example, facilities such as a “private dining room offering a night view” and a “private dining room”, dishes such as “Italian dishes”, “Spanish dishes”, “matured meat”, “roast beef” and “sweets”, drinks such as “red wine” and “white wine”, service such as “all you can drink” and “discount service”, and location such as “close to the station” are set.

FIG. 6 illustrates an establishment table. In the establishment table, name (establishment name), identification information (establishment ID), establishment information, an establishment image, the number of times of use of each establishment, a search condition corresponding to each establishment, characteristic information corresponding to the search condition and a characteristic image corresponding to the characteristic information, or the like, are stored in association with one another for each of a plurality of establishments. The establishment ID is information uniquely allocated to each establishment. The establishment information is information indicating address, access, phone number, e-mail address, URL, outline, or the like, of each establishment. The establishment image is an image of the establishment. The number of times of use is the number of times each establishment is utilized by all the users of the information providing system 1 using the information providing system 1.

The search condition corresponding to each establishment, the characteristic information corresponding to the search condition and the characteristic image corresponding to the characteristic information are registered in advance by the establishment terminal 3 provided at each establishment. The characteristic information associated with each search condition is arbitrarily set by a person related to the establishment. Therefore, the search condition does not always correspond to the characteristic information on a one-to-one basis, and there is a possibility that the same characteristic information may be associated with a plurality of different search conditions. The characteristic image is an image of a characteristic indicated by the corresponding characteristic information.

Schematic Configuration of Establishment Terminal 3

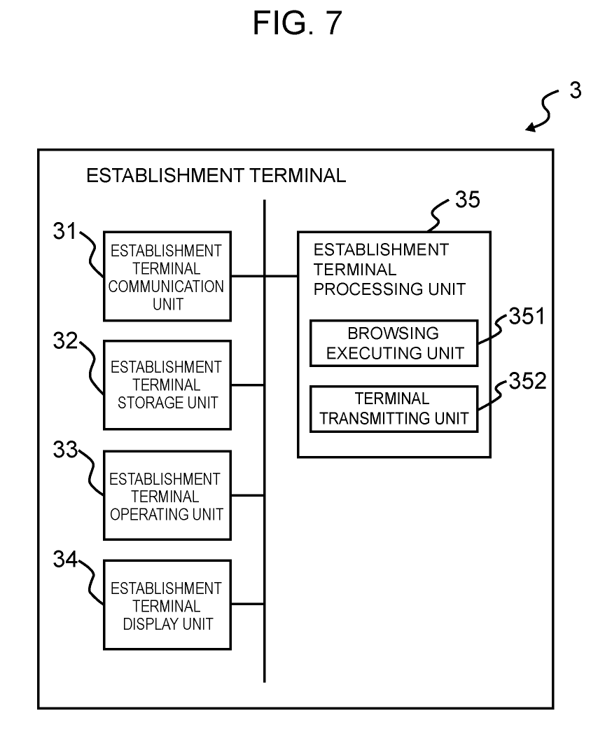

FIG. 7 is a diagram illustrating an illustrative schematic configuration of the establishment terminal 3.

The establishment terminal 3 is connected to the server 2 via the Internet 8 and communicates with the server 2. The establishment terminal 3 accepts registration of a search condition corresponding to each establishment, characteristic information corresponding to the search condition and a characteristic image corresponding to the characteristic information in accordance with input operation by the person related to the establishment. To achieve this, the establishment terminal 3 includes an establishment terminal communication unit 31, an establishment terminal storage unit 32, an establishment terminal operating unit 33, an establishment terminal display unit 34 and an establishment terminal processing unit 35.

Note that, in the present embodiment, while a personal computer (PC) is assumed as the establishment terminal 3, the present invention is not limited to this. The establishment terminal 3 only has to be one to which the present invention can be applied, and, for example, may be an information processing apparatus such as a multifunctional mobile phone (so-called “smartphone”), a mobile phone (so-called “feature phone”), a PDA (Personal Digital Assistant), portable game machine, a portable music player, a tablet terminal, a tablet PC and a notebook PC. Further, the establishment terminal 3 may be a menu terminal, or the like, that is disposed at the establishment and that is handled by the person related to the establishment.

The establishment terminal communication unit 31 includes a communication interface circuit, and connects the establishment terminal 3 to the Internet 8. The establishment terminal communication unit 31 transmits data supplied from the establishment terminal processing unit 35 to the server 2, or the like, via a network. Further, the establishment terminal communication unit 31 supplies data received from the server 2, or the like, to the establishment terminal processing unit 35 via a network.

The establishment terminal storage unit 32 includes, for example, a semiconductor memory device. The establishment terminal storage unit 32 stores an operating system program, a driver program, an application program, data, or the like, to be used for processing at the establishment terminal processing unit 35. For example, the establishment terminal storage unit 32 stores an input device driver program for controlling the establishment terminal operating unit 33, an output device driver program for controlling the establishment terminal display unit 34, or the like, as the driver program. Further, as the application program, the establishment terminal storage unit 32 stores a browsing program, or the like, that displays a registration screen for registering a search condition, characteristic information, a characteristic image, or the like, input by the person related to the establishment operating the establishment terminal operating unit 33, in the server 2. Various kinds of programs may be installed on the establishment terminal storage unit 32 using a publicly known setup program, or the like, from a non-transitory portable computer-readable storage medium such as, for example, a CD-ROM and a DVD-ROM. Further, the establishment terminal storage unit 32 may temporarily store temporal data relating to predetermined processing.

The establishment terminal operating unit 33 may be any device that allows operation of the establishment terminal 3, and, for example, is a touch panel, a key button, or the like. The person related to the establishment can input a character, a number, a symbol, or the like, using the establishment terminal operating unit 33. If the establishment terminal operating unit 33 is operated by the person related to the establishment, the establishment terminal operating unit 33 generates a signal corresponding to the operation. Then, the generated signal is supplied to the establishment terminal processing unit 35 as an instruction of the person related to the establishment.

The establishment terminal display unit 34 may also be any device that allows display of a video, an image, or the like, and, is, for example, a liquid crystal display, an organic EL (Electro-Luminescence) display, or the like. The establishment terminal display unit 34 displays a video in accordance with video data, an image in accordance with image data, or the like, supplied from the establishment terminal processing unit 35.

The establishment terminal processing unit 35 includes one or more processors and peripheral circuits of the processors. The establishment terminal processing unit 35 generally controls the whole operation of the establishment terminal 3, and is, for example, a CPU. The establishment terminal processing unit 35 controls operation of the establishment terminal communication unit 31, the establishment terminal display unit 34, or the like, so that various kinds of processing of the establishment terminal 3 are executed in accordance with an appropriate procedure on the basis of the programs stored in the establishment terminal storage unit 32, operation of the establishment terminal operating unit 33, or the like. The establishment terminal processing unit 35 executes processing on the basis of the programs (such as the operating system program, the driver program and the application program) stored in the establishment terminal storage unit 32. Further, the establishment terminal processing unit 35 can execute a plurality of programs (such as application programs) in parallel.

The establishment terminal processing unit 35 includes a browsing executing unit 351, a terminal transmitting unit 352, or the like. Each of the units is a function module implemented by programs executed by the processor of the establishment terminal processing unit 35. Alternatively, each of these units may be implemented at the establishment terminal 3 as an independent integrated circuit, microprocessor or firmware.

Functions of Establishment Terminal 3

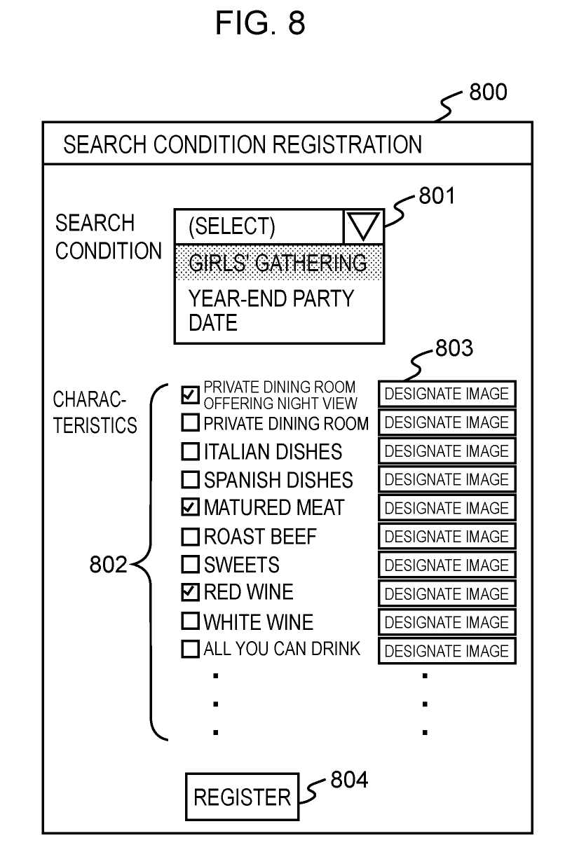

FIG. 8 is a diagram illustrating an illustrative registration screen 800 displayed at the establishment terminal 3.

The registration screen 800 is a screen for registering a search condition corresponding to each establishment, characteristic information corresponding to the search condition and a characteristic image corresponding to the characteristic information, and is displayed by a display function of the establishment terminal 3. The registration screen 800 is displayed in the case where each person related to the establishment requests for display of the registration screen 800. In the registration screen 800, a search condition selection drop-down list 801, a characteristic information selection check box 802, a characteristic image designation button 803, a register button 804, or the like, are displayed.

The search condition selection drop-down list 801 is a drop-down list for allowing the person related to the establishment to select and input a search condition corresponding to each establishment. In the search condition selection drop-down list 801, all (a plurality of) search conditions defined in the information providing system 1, registered in the search condition table are displayed in a selectable manner.

The characteristic information selection check box 802 is a check box for allowing the person related to the establishment to designate and input characteristic information corresponding to the search condition selected from the search condition selection drop-down list 801. In the characteristic information selection check box 802, all (a plurality of) characteristic information defined in the information providing system 1, registered in the characteristic information table are displayed in a selectable manner. In this manner, in the registration screen 800, each characteristic information is displayed in association with the search condition selected by the person related to the establishment, or the like, in a selectable manner by the person related to the establishment, or the like.

The characteristic image designation button 803 is a button for designating a characteristic image corresponding to the characteristic information designated by the characteristic information selection check box 802. If the characteristic image designation button 803 is depressed, a screen for designating a file indicating the characteristic image is displayed.

Note that, in place of or in addition to the search condition selection drop-down list 801 and/or the characteristic information selection check box 802, a text box which allows the user to input an arbitrary term as the search condition and/or the characteristic information may be displayed. By this means, the person related to the establishment, or the like, can register (add) a desired search condition or characteristic information as the search condition or the characteristic information relating to the establishment.

If the register button 804 is depressed (selected) by the person related to the establishment, or the like, a registration request for registering each information item input in the registration screen 800 in the server 2 is transmitted from the establishment terminal 3 to the server 2. The registration request includes each information item input at the registration screen 800 and an establishment ID, or the like, of the establishment where the establishment terminal 3 is provided.

Schematic Configuration of User Terminal 4

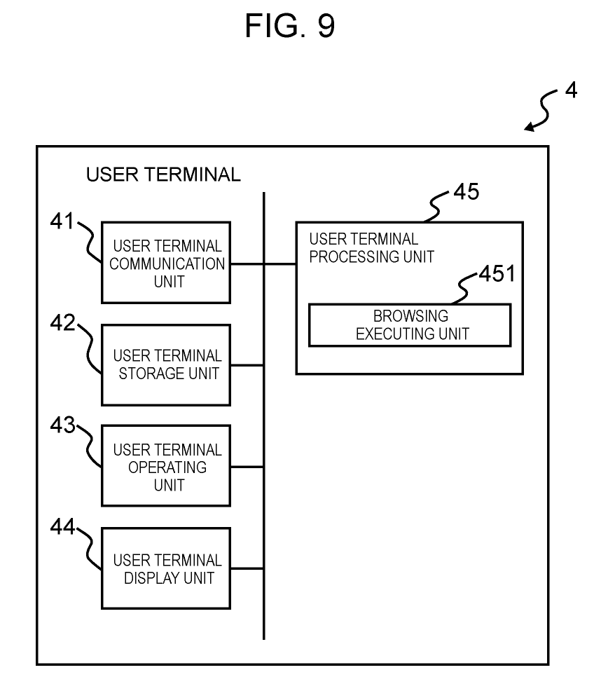

FIG. 9 is a diagram illustrating an illustrative schematic configuration of the user terminal 4.

The user terminal 4 is connected to the server 2 via the base station 5, the mobile communication network 6, the gateway 7 and the Internet 8 and communicates with the server 2. The user terminal 4 requests for display of predetermined information, or the like, to the server 2 in accordance with operation of the user terminal operating unit 43 (such as a button) by the user who utilizes the establishment. Further, the user terminal 4 receives display data relating to the predetermined information, or the like, from the server 2 and displays the display data. To achieve this, the user terminal 4 includes a user terminal communication unit 41, a user terminal storage unit 42, a user terminal operating unit 43, a user terminal display unit 44 and a user terminal processing unit 45.

Note that, in the present embodiment, while a multifunctional mobile phone is assumed as the user terminal 4, the present invention is not limited to this. The user terminal 4 only has to be one to which the present invention can be applied, and, for example, may be a mobile phone, a portable information assistant, portable game machine, a portable music player, a tablet terminal, a tablet PC, a notebook PC, or the like. Further, the user terminal 4 may be a plurality of menu terminals, or the like, that are provided at the establishment and that allow the user of the establishment to order menu items.

The user terminal communication unit 41 includes a communication interface circuit including an antenna whose receiving bandwidth is a predetermined frequency bandwidth, and connects the user terminal 4 to a radio communication network.

The user terminal communication unit 41 establishes a radio signal line using a CDMA (Code Division Multiple Access) scheme, or the like, with the base station 5 via a channel allocated by the base station 5 and performs communication with the base station 5. Then, the user terminal communication unit 41 transmits data supplied from the user terminal processing unit 45 to the server 2, or the like. Further, the user terminal communication unit 41 supplies data received from the server 2, or the like, to the user terminal processing unit 45.

The user terminal storage unit 42, for example, includes a semiconductor memory device. The user terminal storage unit 42 stores an operating system program, a driver program, an application program, data, or the like, to be used for processing at the user terminal processing unit 45. For example, the user terminal storage unit 42 stores an input device driver program for controlling the user terminal operating unit 43, an output device driver program for controlling the user terminal display unit 44, or the like, as the driver program. Further, the user terminal storage unit 42 stores a program for acquiring and displaying display data relating to a list of establishments, or the like, as the application program. Various kinds of programs may be installed to the user terminal storage unit 42 using a publicly known setup program, or the like, from a non-transitory portable computer-readable storage medium such as, for example, a CD-ROM and a DVD-ROM. Further, the user terminal storage unit 42 may temporarily store temporal data relating to predetermined processing.

The user terminal operating unit 43 may be any device that allows operation of the user terminal 4, and is, for example, a touch panel, a key button, or the like. The user can input a character, a number, a symbol, or the like, using the user terminal operating unit 43. If the user terminal operating unit 43 is operated by the user, the user terminal operating unit 43 generates a signal corresponding to the operation. Then, the generated signal is supplied to the user terminal processing unit 45 as an instruction of the user.

The user terminal display unit 44 may also be any device that enables display of a video, an image, or the like, and is, for example, a liquid crystal display, an organic EL display, or the like. The user terminal display unit 44 displays a video in accordance with video data, an image in accordance with image data, or the like, supplied from the user terminal processing unit 45.

The user terminal processing unit 45 includes one or more processors and peripheral circuits of the processors. The user terminal processing unit 45 generally controls the whole operation of the user terminal 4 and is, for example, a CPU. The user terminal processing unit 45 controls operation of the user terminal communication unit 41, the user terminal display unit 44, or the like, so that various kinds of processing of the user terminal 4 are executed in accordance with an appropriate procedure on the basis of the programs stored in the user terminal storage unit 42, operation of the user terminal operating unit 43, or the like. The user terminal processing unit 45 executes processing on the basis of programs (such as an operating system program, a driver program and an application program) stored in the user terminal storage unit 42. Further, the user terminal processing unit 45 can execute a plurality of programs (such as application programs) in parallel.

The user terminal processing unit 45 includes at least a browsing executing unit 451. The browsing executing unit 451 is a function module implemented by programs executed by the processor of the user terminal processing unit 45. Alternatively, the browsing executing unit 451 may be implemented at the user terminal 4 as an independent integrated circuit, microprocessor or firmware.

The browsing executing unit 451 acquires and displays display data relating to a list of establishments, or the like. That is, the browsing executing unit 451 transmits a request for displaying a screen relating to the list of establishments to the server 2 via the user terminal communication unit 41 in response to an instruction from the user. Further, the browsing executing unit 451 receives corresponding display data from the server 2 via the user terminal communication unit 41. The browsing executing unit 451 creates drawing data on the basis of the received display data. That is, the browsing executing unit 451 creates drawing data by analyzing the received display data to specify control data and content data and laying out the specified content data on the basis of the specified control data. The browsing executing unit 451 then outputs the created drawing data to the user terminal display unit 44.

Functions of User Terminal 4

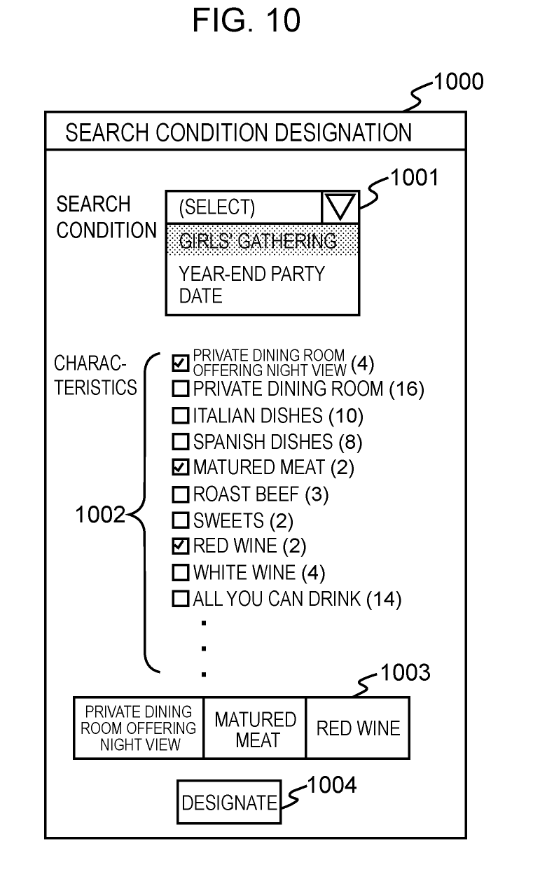

FIG. 10 is a diagram illustrating an illustrative designation screen 1000 displayed at the user terminal 4.

The designation screen 1000 is a screen for accepting designation of a search condition and characteristic information by the user, and is displayed using a display function of the user terminal 4. The designation screen 1000 is displayed in the case where a user of each user terminal 4 requests for displaying the designation screen 1000. In the designation screen 1000, a search condition selection drop-down list 1001, a characteristic information selection check box 1002, a characteristic information display pane 1003, a designation button 1004, or the like, are displayed.

The search condition selection drop-down list 1001 is a drop-down list for selecting and inputting a search condition requested by the user. In the search condition selection drop-down list 1001, all search conditions defined in the information providing system 1, registered in the search condition table are displayed in a selectable manner.

The characteristic information selection check box 1002 is a check box for designating and inputting characteristic information corresponding to a characteristic of an establishment requested by the user as characteristic information corresponding to the search condition selected from the search condition selection drop-down list 1001. In the characteristic information selection check box 1002, all characteristic information defined in the information providing system 1, registered in the characteristic information table is displayed in a selectable manner. Further, in the characteristic information selection check box 1002, the number of establishments for which characteristic information is registered is displayed along with each characteristic information. By this means, the user can recognize the number of establishments having each characteristic, and can appropriately set priority, or the like, of each characteristic information.

The characteristic information display pane 1003 is a display pane for inputting priority of each designated and input characteristic information in the case where a plurality of items of characteristic information are designated and input by the characteristic information selection check box 1002. In the characteristic information display pane 1003, all the characteristic information designated and input by the characteristic information selection check box 1002 is displayed so that the order can be changed. In the characteristic information display pane 1003, priority of each characteristic information is set such that, among the displayed characteristic information, priority of characteristic information displayed on the leftmost side is the highest and priority becomes lower for characteristic information displayed on the right side. The user can designate priority of each characteristic information by changing arrangement (order) of each characteristic information displayed in the characteristic information display pane 1003.

Note that, in place of or in addition to the search condition selection drop-down list 1001, the characteristic information selection check box 1002 and/or the characteristic information display pane 1003, a text box that allows the user to input an arbitrary term or numerical value as a search condition, characteristic information and/or priority may be displayed.

If the designation button 1004 is depressed (selected) by the user, an establishment list display request for requesting for display of a list of establishments corresponding to the search condition designated by the user in the designation screen 1000 is transmitted from the user terminal 4 to the server 2. The establishment list display request includes the search condition and the characteristic information designated by the user in the designation screen 1000, priority of the characteristic information, or the like.

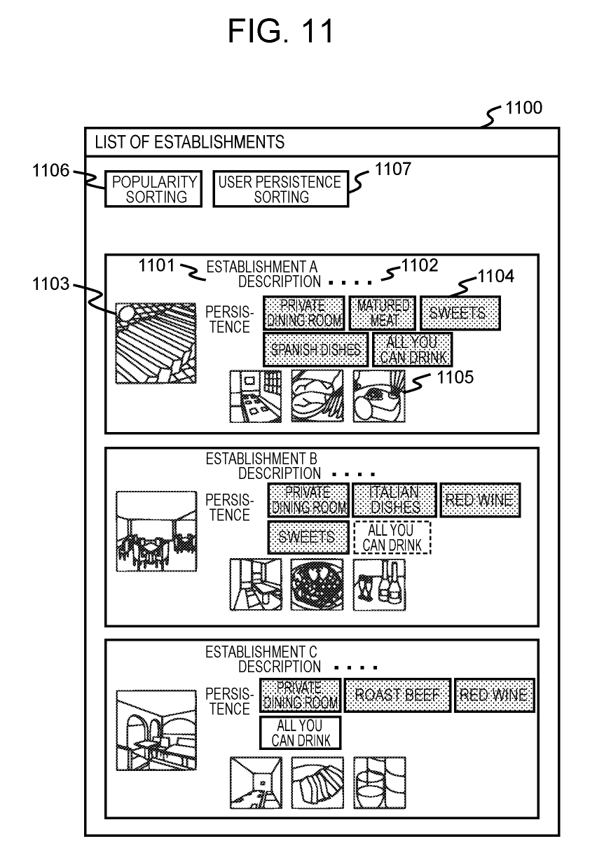

FIG. 11 is a diagram illustrating an illustrative establishment list screen 1100 displayed at the user terminal 4.

The establishment list screen 1100, which is a screen for displaying a list of establishments corresponding to the search condition designated by the user, is displayed by a display function of the user terminal 4. The establishment list screen 1100 is displayed in the case where a designation button 1004 is depressed (selected) in the designation screen 1000 by a user of each user terminal 4. In the establishment list screen 1100, in the establishment table, a list of establishments associated with the search condition designated by the user in the establishment table are displayed such that the establishments are arranged in descending order of the number of items of characteristic information associated with the search condition. In the establishment list screen 1100, establishment name 1101, description 1102, an establishment image 1103, persistence 1104, a characteristic image 1105, or the like, of each establishment are displayed for each of the establishments in the list. Further, in the establishment list screen 1100, a popularity sorting button 1106, a user persistence sorting button 1107, or the like, are displayed.

The establishment name 1101 is the name of each establishment stored in the establishment table. The description 1102 is an information item indicated in establishment information on each establishment stored in the establishment table. The establishment image 1103 is an establishment image of each establishment stored in the establishment table. The establishment name 1101 and the establishment image 1103 are linked to a page displaying information on each establishment in detail, and the user can browse the page displaying information on each establishment in detail by depressing the establishment name 1101 or the establishment image 1103.

The persistence 1104 is characteristic information on each establishment stored in the establishment table. In the persistence 1104, characteristic information stored in association with the search condition designated by the user and other characteristic information are displayed so that the user can distinguish between the characteristic information and the other characteristic information. In the establishment list screen 1100, the characteristic information stored in association with the search condition designated by the user is shaded. A characteristic image corresponding to each characteristic information is linked with the persistence 1104, and the user can browse the characteristic image corresponding to the characteristic information relating to each persistence 1104 by depressing each persistence 1104.

The characteristic image 1105 is a characteristic image of each establishment stored in the establishment table. As the characteristic image 1105, a characteristic image corresponding to characteristic information associated with the search condition designated by the user among the characteristic information relating to each persistence 1104 is displayed. Note that the number of characteristic images 1105 to be displayed is limited to a predetermined number, and characteristic images corresponding to a predetermined number of items of characteristic information may be displayed in descending order of priority as the characteristic image 1105. Further, in the case where the number of items of characteristic information associated with the search condition designated by the user is less than the predetermined number, characteristic images corresponding to other characteristic information may be displayed.

The popularity sorting button 1106 is a button for sorting establishments displayed in the list in order of popularity. If the popularity sorting button 1106 is depressed (selected) by the user, an order change request for sorting establishments associated with the search condition designated by the user in order of popularity is transmitted from the user terminal 4 to the server 2. In this case, a list of establishments (not illustrated) in which establishments associated with the search condition designated by the user in the establishment table are arranged in descending order of the number of times of use of each establishment stored in the establishment table is created by the server 2 and displayed at the user terminal 4.

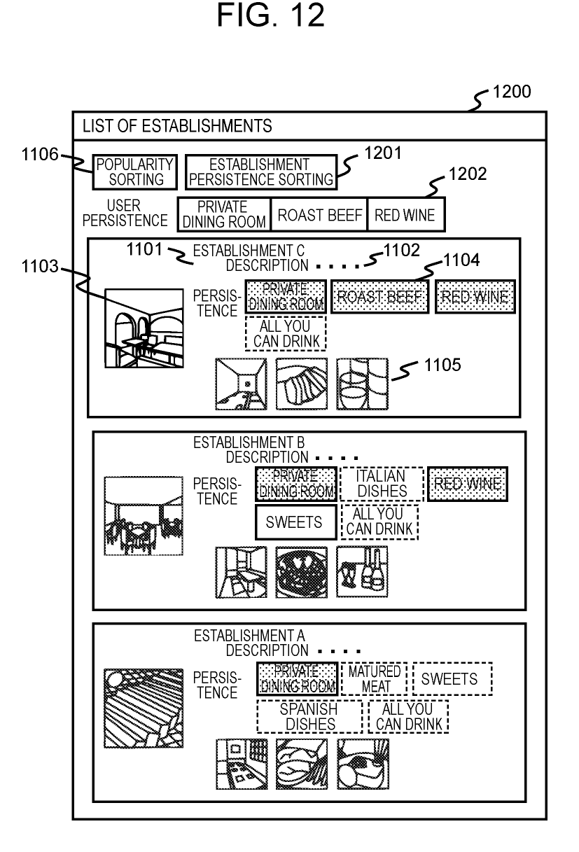

The user persistence sorting button 1107 is a button for sorting establishments displayed in the list on the basis of the number of characteristics of an establishment requested by the user. If the user persistence sorting button 1107 is depressed (selected) by the user, an order change request for sorting the establishments associated with the search condition designated by the user on the basis of the number of characteristics of an establishment required by the user is transmitted from the user terminal 4 to the server 2. In this case, an establishment list screen (FIG. 12) in which the establishments associated with the search condition designated by the user in the establishment table are arranged on the basis of the number of items of characteristic information associated with the search condition and corresponding to the characteristic of an establishment requested by the user is displayed at the user terminal 4.

FIG. 12 is a diagram illustrating an illustrative establishment list screen 1200 displayed at the user terminal 4.

The establishment list screen 1200 is a screen for displaying list of establishments corresponding to the search condition designated by the user and is displayed by a display function of the user terminal 4. The establishment list screen 1200 is displayed in the case where the user persistence sorting button 1107 is depressed (selected) in the establishment list screen 1100 by the user of each user terminal 4. In the establishment list screen 1200, a list in which establishments associated with the search condition designated by the user in the establishment table are arranged on the basis of the number of items of characteristic information associated with the search condition and corresponding to a characteristic of an establishment requested by the user is displayed. In the establishment list screen 1200, in a similar manner to the establishment list screen 1100, establishment name 1101, description 1102, an establishment image 1103, persistence 1104, a characteristic image 1105, or the like, of each establishment are displayed for each of establishments displayed in the list. Further, in the establishment list screen 1200, a popularity sorting button 1106, an establishment persistence sorting button 1201, user persistence 1202, or the like, are displayed.

In the establishment list screen 1200, characteristic information associated with the search condition designated by the user and corresponding to a characteristic of an establishment requested by the user in the persistence 1104, and other characteristic information are displayed such that the user can distinguish between the characteristic information and the other characteristic information. In the establishment list screen 1200, the characteristic information associated with the search condition designated by the user and corresponding to the character of the establishment requested by the user is shaded.

Further, in the establishment list screen 1200, as the characteristic image 1105, a characteristic image corresponding to each characteristic information associated with the search condition designated by the user and corresponding to the characteristic of the establishment requested by the user among the characteristic information relating to each persistence 1104 is displayed.

The establishment persistence sorting button 1201 is a button for sorting the establishments displayed in the list in descending order of the number of items of characteristic information associated with the search condition designated by the user. If the establishment persistence sorting button 1201 is depressed (selected) by the user, an order change request for sorting the establishments associated with the search condition designated by the user in descending order of the number of items of characteristic information associated with the search condition is transmitted from the user terminal 4 to the server 2. In this case, the establishment list screen 1100 illustrated in FIG. 11 is displayed at the user terminal 4.

Further, in the establishment list screen 1200, as the user persistence 1202, a list of items of characteristic information designated and input by the user, which are arranged in descending order of priority, is displayed.

In the establishment list screen 1100 illustrated in FIG. 11, a list of establishments having characteristic information associated with the search condition of a “girls' gathering” designated by the user is displayed in order of an establishment A having five items of characteristic information, an establishment B having four items of characteristic information and an establishment C having three items of characteristic information. Meanwhile, in the establishment list screen 1200 illustrated in FIG. 12, a list of establishments having characteristic information associated with the search condition of a “girls' gathering” designated by the user and corresponding to a characteristic of an establishment requested by the user is displayed in order of an establishment C having three items of characteristic information, an establishment B having two items of characteristic information and an establishment A having one item of characteristic information. In this manner, in the establishment list screen 1200, a list of establishments is displayed in descending order of a degree of match with the request of the user.

Example 1 of Operation Sequence of Information Providing System 1

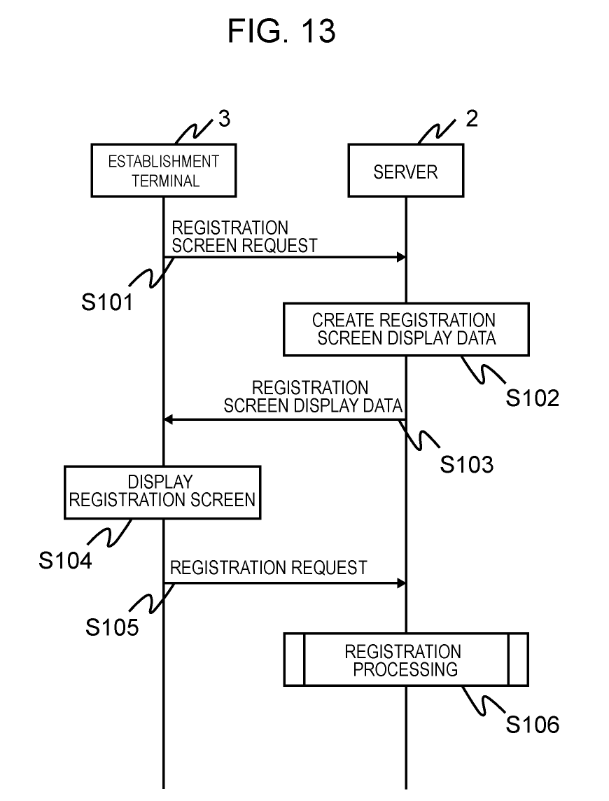

FIG. 13 is a diagram illustrating an illustrative operation sequence of the information providing system 1. This operation sequence is executed in cooperation with each element of the server 2 and the establishment terminal 3 mainly by the server processing unit 23 and the establishment terminal processing unit 35 on the basis of the programs stored in advance in the server storage unit 22 and the establishment terminal storage unit 32.

First, the terminal transmitting unit 352 of the establishment terminal 3 transmits a registration screen request to the server 2 via the establishment terminal communication unit 31 in accordance with operation of the establishment terminal operating unit 33 by the person related to the establishment (step S101).

Then, if the screen creating unit 231 of the server 2 receives the registration screen request from the establishment terminal 3 via the server communication unit 21, the screen creating unit 231 creates registration screen display data for displaying the registration screen 800 (step S102). The screen creating unit 231 creates the search condition selection drop-down list 801 on the basis of the search condition table, creates the characteristic information selection check box 802 on the basis of the characteristic information table and creates the registration screen display data for displaying the registration screen 800 in which the drop-down list and buttons are respectively disposed at predetermined positions.

The registration screen transmitting unit 232 then transmits the created registration screen display data to the establishment terminal 3 via the server communication unit 21 (step S103).

Then, if the browsing executing unit 351 of the establishment terminal 3 receives the registration screen display data from the server 2 via the establishment terminal communication unit 31, the browsing executing unit 351 displays the registration screen 800 at the establishment terminal display unit 34 on the basis of the received registration screen display data (step S104).

Then, if a register button is depressed by the person related to the establishment using the establishment terminal operating unit 33 with respect to the registration screen 800 displayed at the establishment terminal display unit 34, the browsing executing unit 351 transmits a registration request including the search condition, the characteristic information, the characteristic image and the establishment ID input on the registration screen 800 to the server 2 via the establishment terminal communication unit 31 (step S105).

Then, if the registering unit 233 of the server 2 receives the registration request via the server communication unit 21, the registering unit 233 executes registration processing of registering the search condition, the characteristic information and the characteristic image included in the received registration request in the establishment table in association with the establishment ID (step S106). Details of the registration processing will be described later. The operation sequence ends as described above.

Registration Processing

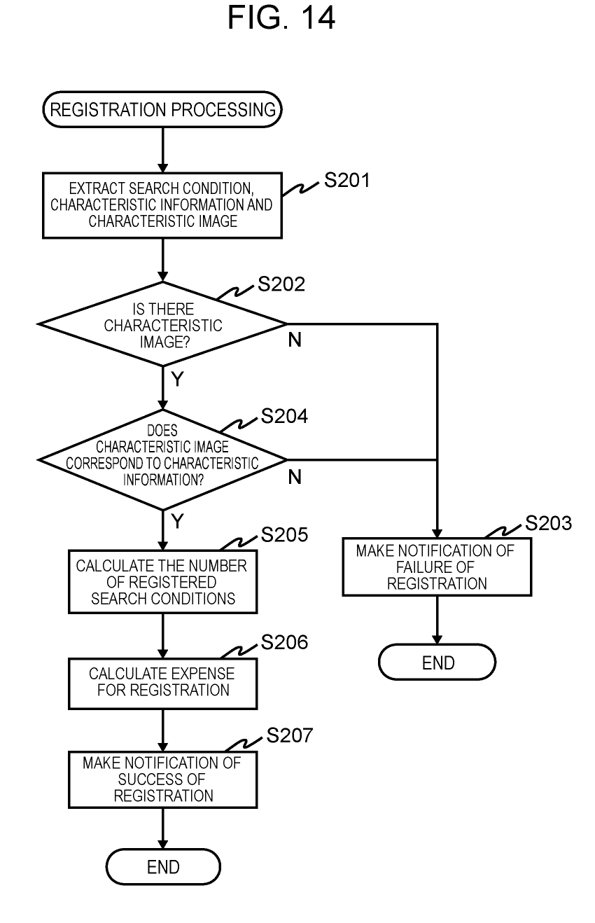

FIG. 14 is a flowchart illustrating illustrative registration processing. The registration processing illustrated in FIG. 14 is executed in step S106 in FIG. 13.

First, the registering unit 233 extracts the search condition, the characteristic information and the characteristic image from the received registration request (step S201).

Then, the registering unit 233 determines whether or not the characteristic image relating to the characteristic information included in the registration request is received along with the registration request by determining whether or not the characteristic image is included in the received registration request (step S202).

In the case where the characteristic image is not received, the registering unit 233 determines to deny registration of the search condition, the characteristic information and the characteristic image. In this case, the registering unit 233 creates display data for displaying a screen (not illustrated) displaying that registration is failed. The registering unit 233 notifies the person related to the establishment that registration is failed by transmitting the created display data to the establishment terminal 3 via the server communication unit 21 (step S203), and a series of step ends.

In this manner, the registering unit 233 registers the search condition, the characteristic information and the characteristic image included in the registration request in association with the establishment under condition that the characteristic image relating to the characteristic information is received along with the registration request. By this means, the information providing system 1 can reliably register the characteristic image along with the characteristic information, so that the user can visually select an establishment that matches the user's request better using the characteristic image.

In the case where the characteristic image is received, the registering unit 233 analyzes the characteristic image included in the registration request to determine whether or not the characteristic image corresponds to the characteristic information (step S204).

For example, the registering unit 233 determines whether or not the characteristic image corresponds to the characteristic information by determining whether or not the characteristic image shows a characteristic (such as a facility, dish and drink) indicated in the characteristic information by utilizing a publicly known machine learning technique. In this case, the registering unit 233 determines whether or not the characteristic image shows a characteristic indicated in the characteristic information using a classifier that has learned in advance so as to output, in the case where an image is input, a degree of appearance of a characteristic indicated in the characteristic information in the input image. The classifier is generated for each characteristic information. The classifier learns in advance using an image including each characteristic and an image not including each characteristic through, for example, deep learning, or the like, and is stored in advance in the server storage unit 22. The registering unit 233 inputs the characteristic image in a classifier corresponding to the characteristic information and determines whether or not the characteristic image shows a characteristic indicated in the characteristic information in accordance with whether or not a degree output from the classifier is equal to or greater than a threshold.

Further, the registering unit 233 may determine whether or not the characteristic image corresponds to the characteristic information by determining whether or not the characteristic image shows a character (such as a facility, dish and drink) indicated in the characteristic information by utilizing a publicly known pattern matching technique. In this case, a plurality of image patterns which respectively show characteristics indicated in each characteristic information are stored in advance in the server storage unit 22 for each characteristic information. The registering unit 233 calculates a degree of similarity between the characteristic image and each image pattern corresponding to the characteristic information and determines whether or not the characteristic image shows a characteristic indicated in the characteristic information in accordance with whether or not there exists an image pattern for which the calculated degree of similarity is equal to or greater than the threshold. The degree of similarity can be made, for example, a normalized cross correlation value between the characteristic image and an image obtained by scaling the image pattern to the same size as the characteristic image.

In the case where the characteristic image does not correspond to the characteristic information, the registering unit 233 determines to deny registration of the search condition, the characteristic information and the characteristic image. In this case, the registering unit 233 creates display data for displaying a screen (not illustrated) displaying that registration is failed. The registering unit 233 notifies the person related to the establishment that registration is failed by transmitting the created display data to the establishment terminal 3 via the server communication unit 21 (step S203), and a series of step ends.

In this manner, the registering unit 233 registers the search condition, the characteristic information and the characteristic image included in the registration request in association with the establishment under condition that the characteristic image included in the registration request corresponds to the characteristic information included in the registration request. By this means, the information providing system 1 can reliably register the characteristic image that shows the characteristic information, so that the user can visually select an establishment that matches the user's request better using the characteristic image.

In the case where the characteristic image corresponds to the characteristic information, the registering unit 233 determines to permit registration of the search condition, the characteristic information and the characteristic image. In this case, the registering unit 233 reads out the establishment table and calculates the number of search conditions which have already been registered in association with the establishment corresponding to the establishment terminal 3 that transmits the registration request (step S205).

The registering unit 233 then determines expense for registration (step S206). The registering unit 233 determines expense for registration in accordance with the number of items of characteristic information included in the registration request, that is, the number of items of characteristic information to be registered in association with the search condition included in the registration request. The registering unit 233 determines expense for registration so that the expense for registration becomes higher as the number of items of characteristic information to be registered is larger. By this means, each establishment registers only appropriate characteristic information that has high relevance with the search condition to prevent increase in expense for registration. Therefore, in a screen of a list of establishments associated with the search condition designated by the user, only characteristic information with high relevance with the search condition is displayed, so that the user can find an establishment that matches the search condition better with high accuracy.

Note that the registering unit 233 may determine expense for registration so that, the expense for registration is fixed in the case where the number of items of characteristic information to be registered is equal to or smaller than a predetermined number, and the expense for registration becomes higher as the number of items of characteristic information to be registered becomes larger in the case where the number of items of characteristic information to be registered exceeds the predetermined number. By this means, because each establishment can register characteristic information of up to a certain number at a certain amount of money, it is possible to prevent a situation where only an extremely small number of items of characteristic information are registered by each establishment and appropriate characteristic information is not registered.

Further, the registering unit 233 may determine the expense for registration so that expense per one item of characteristic information becomes higher as the number of search conditions that have already been registered in association with each establishment, calculated in step S205 is larger. By this means, each establishment registers only a search condition surely recommended by each establishment to prevent increase in expense for registration. Therefore, in a screen of a list of establishments associated with the search condition designated by the user, only establishments that surely satisfy the search condition are displayed, so that the user can find an establishment that matches the search condition better with high accuracy.

The registering unit 233 then creates display data for displaying a screen (not illustrated) displaying that registration is successful. The registering unit 233 notifies the person related to the establishment that registration is successful by transmitting the created display data to the establishment terminal 3 via the server communication unit 21 (step S207), and a series of step ends.

Note that the processing in step S202 may be omitted, and the registering unit 233 may register the search condition and the characteristic information also in the case where a characteristic image is not received. Further, the processing in step S204 may be omitted, and the registering unit 233 may register the search condition and the characteristic information also in the case where the characteristic image does not correspond to the characteristic information.

Example 2 of Operation Sequence of Information Providing System 1

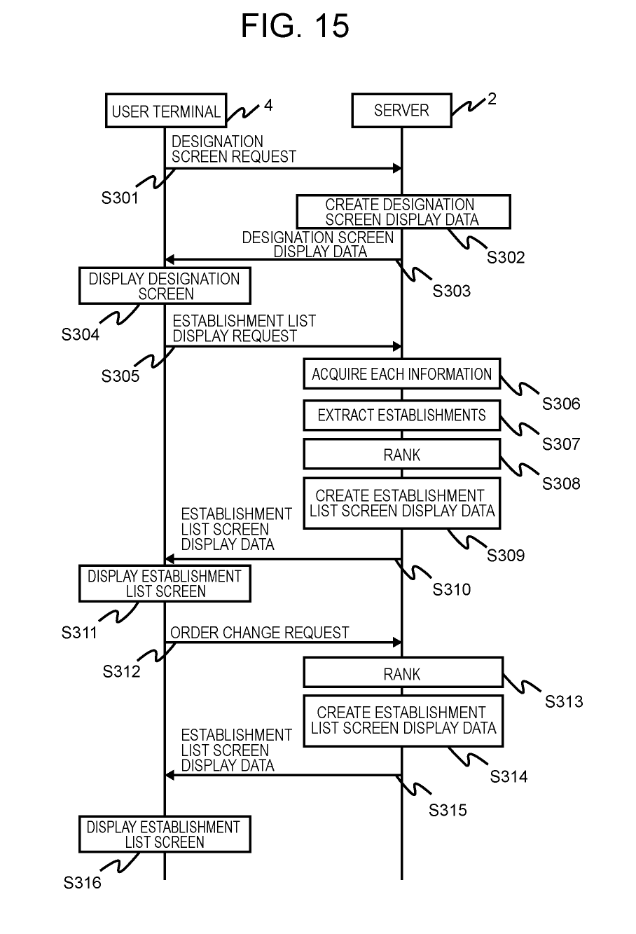

FIG. 15 is a diagram illustrating an illustrative operation sequence of the information providing system 1. The operation sequence is executed in cooperation with each element of the server 2 and the user terminal 4 mainly by the server processing unit 23 and the user terminal processing unit 45 on the basis of the programs stored in advance in the server storage unit 22 and the user terminal storage unit 42.

The browsing executing unit 451 of the user terminal 4 transmits a designation screen request to the server 2 via the user terminal communication unit 41 in accordance with operation of the user terminal operating unit 43 by the user (step S301). For example, the designation screen request is transmitted by the user designating a link (such as a link for displaying menu) included in a site for introducing each establishment put on a predetermined information providing site using the user terminal 4.

Then, if the screen creating unit 231 of the server 2 receives the designation screen request from the user terminal 4 via the server communication unit 21, the screen creating unit 231 creates designation screen display data for displaying the designation screen 1000 (step S302). The screen creating unit 231 creates the search condition selection drop-down list 1001 on the basis of the search condition table, creates the characteristic information selection check box 1002 on the basis of the characteristic information table and creates the designation screen display data for displaying the designation screen 1000 in which the drop-down list, the display pane and the buttons are respectively disposed at predetermined positions.

The designation screen transmitting unit 234 then transmits the created designation screen display data to the user terminal 4 via the server communication unit 21 (step S303).

Then, if the browsing executing unit 451 of the user terminal 4 receives the designation screen display data from the server 2 via the user terminal communication unit 41, the browsing executing unit 451 displays the designation screen 1000 at the user terminal display unit 44 on the basis of the received designation screen display data (step S304).

Then, if a designation button is depressed by the user using the user terminal operating unit 43 with respect to the designation screen 1000 displayed at the user terminal display unit 44, the browsing executing unit 451 transmits an establishment list display request including the search condition, the characteristic information and priority designated in the designation screen 1000 to the server 2 via the user terminal communication unit 41 (step S305).

Then, if the search condition receiving unit 235 of the server 2 receives the establishment list display request from the user terminal 4 via the server communication unit 21, the acquiring unit 236 acquires the search condition, the characteristic information and the priority included in the received establishment list display request (step S306). The acquiring unit 236 acquires the search condition received from the user terminal 4 as a search condition of an establishment requested by the user and acquires the characteristic information received from the user terminal 4 as characteristic information corresponding to a characteristic of an establishment requested by the user.

The extracting unit 237 then extracts establishments associated with the search condition included in the establishment list display request from the establishment table (step S307).

The ranking unit 238 then ranks the establishments extracted by the extracting unit 237 on the basis of the number of items of characteristic information associated with the search condition included in the establishment list display request in the establishment table (step S208). The ranking unit 238 ranks the establishments in descending order of the number of items of characteristic information associated with each establishment and the search condition designated by the user (so that ranking is higher as the number of items of the characteristic information is larger) in the establishment table.

The screen creating unit 231 then creates establishment list screen display data displaying the establishments extracted by the extracting unit 237 arranged in order ranked by the ranking unit 238 (step S309). The screen creating unit 231 reads out establishment name, establishment information, establishment images, characteristic information, characteristic images, or the like, of the establishments extracted by the extracting unit 237 and creates the establishment list screen display data for displaying the establishment list screen 1100 in which the read out information are arranged and displayed in order ranked by the ranking unit 238 and in which the buttons are respectively disposed at predetermined positions. That is, in the establishment list screen 1100, a list of establishments associated with the search condition designated by the user is displayed in association with the characteristic information associated with the search condition.

The establishment screen transmitting unit 239 then transmits the created establishment list screen display data to the user terminal 4 via the server communication unit 21 (step S310).

Then, if the browsing executing unit 451 of the user terminal 4 receives the establishment list screen display data from the server 2 via the user terminal communication unit 41, the browsing executing unit 451 displays the establishment list screen 1100 at the user terminal display unit 44 on the basis of the received establishment list screen display data (step S311).

Then, if the user persistence sorting button 1107 is depressed by the user using the user terminal operating unit 43 with respect to the establishment list screen 1100 displayed at the user terminal display unit 44, the browsing executing unit 451 transmits an order change request that designates user persistence order to the server 2 via the user terminal communication unit 41 (step S312).

Then, if the ranking unit 238 of the server 2 receives the order change request from the user terminal 4 via the server communication unit 21, the ranking unit 238 ranks the establishments extracted by the extracting unit 237 on the basis of the number of items of characteristic information that matches the characteristic information acquired by the acquiring unit 236 among the characteristic information associated with the search condition included in the establishment list display request in the establishment table(step S313). The ranking unit 238 ranks the establishments in descending order of the number of items of characteristic information corresponding to the characteristic of the establishment requested by the user among the characteristic information associated with each establishment and the search condition designated by the user (so that ranking is higher as the number of items of the characteristic information is larger). By this means, the information providing system 1 can display the establishments arranged in descending order of a degree of match with persistence of each user.

Note that the ranking unit 238 may correct the number of items of characteristic information that match the characteristic information acquired by the acquiring unit 236 among the characteristic information associated with the search condition included in the establishment list display request in the establishment table on the basis of priority of each characteristic information. In this case, the ranking unit 238 allocates higher points to higher priority for each characteristic information corresponding to the characteristic of the establishment requested by the user among the characteristic information associated with each establishment and the search condition designated by the user in the establishment table. The ranking unit 238 then calculates a sum of the points allocated to each characteristic information for each establishment as the number of items of characteristic information for each establishment. By this means, the information providing system 1 can display the establishment arranged in descending order of a degree of match with persistence of the user with higher accuracy.

The screen creating unit 231 then creates the establishment list screen display data displaying the establishments extracted by the extracting unit 237 arranged in order ranked by the ranking unit 238 (step S314). The screen creating unit 231 creates the establishment list screen display data for displaying the establishment list screen 1100.

The establishment screen transmitting unit 239 then transmits the created establishment list screen display data to the user terminal 4 via the server communication unit 21 (step S315).

Then, if the browsing executing unit 451 of the user terminal 4 receives the establishment list screen display data from the server 2 via the user terminal communication unit 41, the browsing executing unit 451 displays the establishment list screen 1200 at the user terminal display unit 44 on the basis of the received establishment list screen display data (step S316). The operation sequence ends as described above.

Note that the acquiring unit 236 may acquire the characteristic information corresponding to the characteristic of the establishment requested by the user and priority of the characteristic information using other methods instead of receiving the characteristic information and the priority from the user terminal 4. For example, the acquiring unit 236 acquires the characteristic information corresponding to the characteristic of the establishment that the user has reserved, browsed or bookmarked in the past as the characteristic information corresponding to the characteristic of the establishment requested by the user. In this case, the server 2 stores history of establishments that the user has reserved, browsed or bookmarked in the past in the server storage unit 22.

The acquiring unit 236 extracts establishments that the user has reserved, browsed or bookmarked in the past from the history stored in the server storage unit 22 in step S306. The acquiring unit 236 acquires the characteristic information stored in association with the extracted establishments as the characteristic information corresponding to the characteristic of the establishment requested by the user. The acquiring unit 236 then calculates priority for the acquired characteristic information so that priority becomes higher as the number of items of characteristic information stored in association with the extracted establishments is larger. Note that the acquiring unit 236 may acquire the characteristic information stored in association with the extracted establishments and the search condition designated by the user in the establishment table as the characteristic information corresponding to the characteristic of the establishment requested by the user. In this case, the acquiring unit 236 calculates priority for the acquired characteristic information so that priority becomes higher as the number of items of characteristic information stored in association with the extracted establishments and the search condition designated by the user is larger.

In these cases, because the information providing system 1 automatically extracts preference of the user, in the designation screen 1000, display of the characteristic information selection check box 1002 and the characteristic information display pane 1003 is omitted. By this means, the user does not need to input characteristic information and priority, so that it is possible to improve user convenience.

Further, in the case where the search condition receiving unit 235 receives the establishment list display request in step S306, the screen creating unit 231 may create the establishment list screen display data for displaying the establishment list screen 1200 instead of creating the establishment list screen display data for displaying the establishment list screen 1100. In this case, the ranking unit 238 ranks the establishments on the basis of the number of items of characteristic information that matches the characteristic information acquired by the acquiring unit 236 among the characteristic information associated with the search condition included in the establishment list display request in the establishment table in step S308 in a similar manner to the processing in step S313. By this means, the user can browse a list of establishments arranged in descending order of a degree of match with persistence of the user in a short period of time, so that it is possible to improve user convenience of the information providing system 1.

As described in detail above, because the information providing system 1 determines expense for registration in accordance with the number of items of characteristic information registered in association with the search condition, each establishment registers only characteristic information with high relevance with the search condition to prevent increase in expense for registration. By this means, only characteristic information with high relevance with the search condition is displayed in a screen of a list of establishments associated with the search condition designated by the user, so that the user can find an establishment that matches the search condition better with high accuracy.

Further, in the case where there exist a plurality of establishments associated with the search condition designated by the user, the information providing system 1 ranks the establishments on the basis of the number of items of characteristic information associated with the search condition and displays the ranked establishments. By this means, the user can easily find an establishment that matches the search condition better.

Normally, the user confirms whether each establishment matches the user's request by browsing a page displaying information on each establishment that matches the search condition in detail. In the case where a list of establishments that match the search condition, which are randomly arranged is displayed, the user spends a lot of time in finding an establishment that matches the user's request. In the information providing system 1, the establishments are ranked on the basis of the number of items of characteristic information, the user can sequentially browse pages displaying information on each establishment in detail in accordance with the ranked order, so that the user can find an establishment that matches the user's request in a shorter period of time.

Further, in the information providing system 1, because characteristic information on each establishment that matches the search condition is displayed, the user can find an establishment that matches the user's request more easily. Therefore, the information providing system 1 enables the user to select a more satisfying establishment in a shorter period of time.

Other Modified Examples

Note that the establishment list screen displayed at the user terminal 4 is not limited to the establishment list screens 1100, 1200 illustrated in FIG. 11 and FIG. 12. For example, as the establishment list screen, only a list of the search conditions designated by the user and the characteristic images corresponding to the characteristic information stored in association with the establishments corresponding to the search conditions may be displayed. In this case, each characteristic image is linked to the page that displays information on each establishment corresponding to the characteristic image in detail, and the user can browse the page that displays information on the establishment corresponding to the characteristic image in detail by depressing each characteristic image. By this means, the user can visually select an establishment that matches the user's request better from the establishments that satisfy the search condition, so that it is possible to improve user convenience of the information providing system 1.

Further, the establishment terminal storage unit 32 of the establishment terminal 3 and/or the user terminal storage unit 42 of the user terminal 4 may store all or part of the search condition table, the characteristic information table and the establishment table. In this case, the server 2 accesses the establishment terminal storage unit 32 of the establishment terminal 3 and/or the user terminal storage unit 42 of the user terminal 4 when using information included in these various kinds of tables, to acquire information included in the tables, and executes various kinds of processing.

Further, the information providing system 1 may be configured to include only the establishment terminal 3. In this case, the establishment terminal 3 has each function of the server 2 and the user terminal 4. Further, the information providing system 1 may be configured to include only the user terminal 4. In this case, the user terminal 4 has each function of the server 2 and the establishment terminal 3.

A person skilled in the art should understand that it is possible to make various changes, replacements and modifications without deviating from the spirit and the scope of the present invention.

What is claimed is:

1. A control method for a server connectable to a storage circuity in which a plurality of search conditions and a plurality of items of characteristic information indicating characteristics of establishments are stored, and a terminal for registration and a user terminal, the control method comprising controlling the server to execute:
transmitting to the terminal for registration first display data for displaying the plurality of search conditions in a selectable manner and displaying the plurality of items of characteristic information in a selectable manner in association with a selected search condition;
upon receiving a registration request including the search condition and the characteristic information to be associated with the search condition from the terminal for registration, registering the search condition and the characteristic information in association with an establishment; and
upon receiving an establishment list display request including the search condition designated by a user via the user terminal, transmitting to the user terminal second display data for displaying a list of establishments associated with the search condition in association with the characteristic information associated with the search condition,
wherein, in the registration, expense for registration is determined in accordance with the number of items of the characteristic information registered in association with the search condition.

2. The control method according to claim 1, wherein
in the transmission, in the second display data, the establishments associated with the search condition included in the establishment list display request are arranged and displayed in order ranked on the basis of the number of items of the characteristic information registered in association with the search condition.

3. The control method according to claim 1, wherein
in the registration, the expense for registration is determined so that the expense for registration becomes fixed in a case where the number of items of the characteristic information registered in association with the search condition is equal to or smaller than a predetermined number, and the expense for registration becomes higher as the number is larger in a case where the number of items of the characteristic information registered in association with the search condition exceeds the predetermined number.

4. The control method according to claim 1, wherein
in the registration, the expense for registration is determined so that expense per one item of the characteristic information becomes higher as the number of the search conditions registered in association with each establishment is larger.

5. The control method according to claim 1, wherein
in the registration, the search condition and the characteristic information included in the registration request are registered in association with an establishment under condition that an image relating to the characteristic information included in the registration request is received along with the registration request.

6. The control method according to claim 5, wherein
in the registration, in a case where an image relating to the characteristic information included in the registration request is received along with the registration request,
the control method further comprises:
analyzing the image to determine whether or not the image corresponds to the characteristic information; and
registering the search condition and the characteristic information included in the registration request in association with an establishment under condition that the image corresponds to the characteristic information.

7. The control method according to claim 1, wherein
the search condition indicates a usage scene in which a user uses each establishment or purpose of use.

8. The control method according to claim 1, wherein
the characteristic information indicates a facility of each establishment as a characteristic of the establishment.

9. A server connectable to a storage circuity in which a plurality of search conditions and a plurality of items of characteristic information indicating characteristics of establishments are stored, a terminal for registration and a user terminal, the server comprising:
a first transmitting circuity configured to transmit to the terminal for registration first display data for displaying the plurality of search conditions in a selectable manner and displaying the plurality of items of the characteristic information in a selectable manner in association with a selected search condition;
a registering circuity configured to, upon receiving a registration request including the search condition and the characteristic information to be associated with the search condition from the terminal for registration, register the search condition and the characteristic information in association with an establishment; and
a second transmitting circuity configured to, upon receiving an establishment list display request including the search condition designated by a user via the user terminal, transmitting to the user terminal second display data for displaying a list of establishments associated with the search condition in association with the characteristic information associated with the search condition,
wherein the registering circuity determines expense for registration in accordance with the number of items of the characteristic information registered in association with the search condition.

10. A non-transitory tangible computer-readable storage medium having a control program for a server stored therein, the server being connectable to a storage circuity in which a plurality of search conditions and a plurality of items of characteristic information indicating characteristics of establishments are stored, a terminal for registration and a user terminal, the control program causing the server to execute:
transmitting to the terminal for registration first display data for displaying the plurality of search conditions in a selectable manner and displaying the plurality of items of characteristics in a selectable manner in association with a selected search condition;
upon receiving a registration request including the search condition and the characteristic information to be associated with the search condition from the terminal for registration, registering the search condition and the characteristic information in association with an establishment; and
upon receiving an establishment list display request including the search condition designated by a user via the user terminal, transmitting to the user terminal second display data for displaying a list of establishments associated with the search condition in association with the characteristic information associated with the search condition,
wherein, in the registration, expense for registration is determined in accordance with the number of items of the characteristic information registered in association with the search condition.
